(19) United States
(12) Patent Application Publication
(10) Pub. No.: US 2011/0105005 A1
(43) Pub. Date: May 5, 2011

(54) VENTILATION SYSTEM

(75) Inventor: Alessandro Spaggiari, Correggio (IT)

(73) Assignee: SPAL AUTOMOTIVE S.R.L., Correggio (Reggio Emilia) (IT)

(21) Appl. No.: 13/001,129

(22) PCT Filed: Jul. 10, 2009
(86) PCT No.: PCT/IB2009/053018

§ 371 Date: Dec. 23, 2010

(30) Foreign Application Priority Data
Jul. 11, 2008 (IT) BO2008A000433

(51) Int. Cl. B60H 1/00

(52) U.S. Cl. 454/75

(57) ABSTRACT

A ventilation system (1) for vehicles comprises an electric ventilator (2) in turn comprising a fan (4), an electric motor (3) for driving the fan (4) and a microcontroller (6) installed at the motor (3) for controlling the rotation speed of the fan (4), the microcontroller (6) processes one or more vehicle functional parameters according to which it defines the rotation speed of the fan (4).

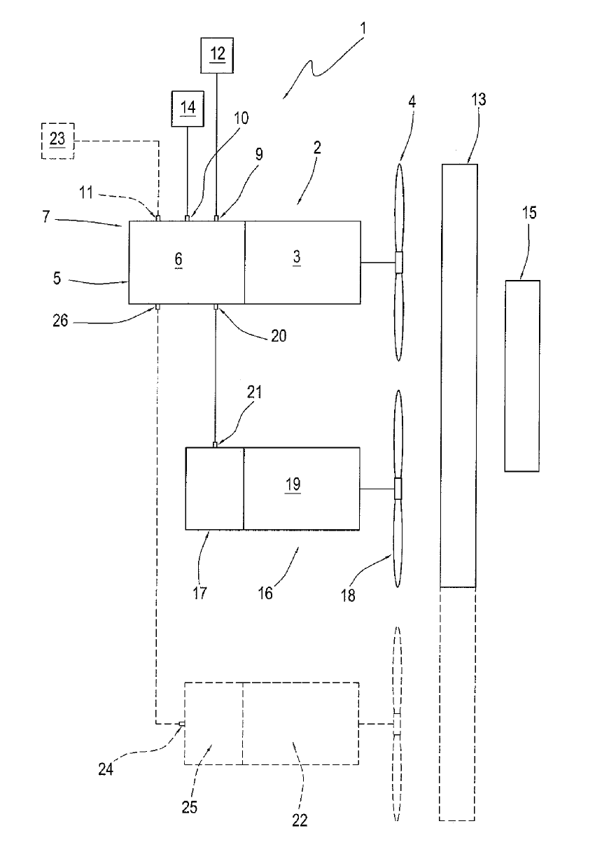

### TECHNICAL FIELD

This invention relates to a ventilation system and, in particular, to a motor vehicle ventilation system comprising one or more electric ventilators.

### BACKGROUND ART

Modern ventilation systems for motor vehicles, especially motor cars, comprise one or more electric ventilators, each defined by a fan combined with an electric motor, and a unit for controlling the ventilators.

The control unit, installed on the board the vehicle, uses sensors mounted in various parts of the vehicle to acquire a plurality of vehicle functional parameters which are processed to generate a signal for controlling the motors of the electric fans.

The electric ventilators comprise a microcontroller that translates the control signal into the fan rotation speed in response to the control unit.

In other words, in prior art solutions, while the vehicle's control unit processes the data from the sensors and translates them into a control signal for the electric fan, the motor's electronic section, that is, the microcontroller, converts the signal into the rotation speed of the fan.

Electric fans may be used in particular to ventilate the vehicle cabin or to cool the radiating bodies normally mounted on board the vehicle, such as, for example, the radiator of the propellant coolant, the motor oil radiator or the coolant condenser of the air conditioning system.

The control signal therefore expresses the different temperature requirements of the radiating bodies mounted on the vehicle.

The control unit is especially designed to perform the above mentioned tasks of acquiring and processing the information from the sensors and is therefore highly complicated in this respect.

In vehicles that are less sophisticated in terms of cooling and ventilation, such as earthmoving machines and farm tractors, the ventilation systems are normally driven by a thermostatic bulb which is combined with the radiator and which controls the activation of the electric fan.

In these vehicles, therefore, engine cooling is never optimized since the ventilation system is controlled as a function of the temperature of the water present in the cooling circuit and not as a function of other important operating temperatures or of the requirements of other radiating bodies mounted on the vehicle.

It should be noted that vehicles of this type cannot be equipped with ventilation systems of the kind described above because these vehicles either do not have control units or the control units they do have are unable to also control the ventilation system.

It should also be observed that very often these vehicles do not have sensors capable of detecting the above mentioned control parameters and it is therefore difficult, if not impossible, to optimize the operation of the electric ventilator.

### DISCLOSURE OF THE INVENTION

In this context, the main purpose of the present invention is to propose a ventilation system which is free of the above mentioned disadvantages.

One aim of this invention is to provide a ventilation system that is efficient and more versatile than prior art ventilation systems.

Another aim of the invention is to provide a ventilation system suitable for mounting on vehicles such as earthmoving machines and farm tractors without sophisticated control units and/or sensors for acquiring the vehicle's operating parameters.

The above mentioned purpose and aims are substantially achieved by a ventilation system having the characteristics defined in the independent claim 1 and in one or more of the dependent claims.

### BRIEF DESCRIPTION OF THE DRAWING

Further features and advantages of the present invention are more apparent in the detailed description below, with reference to a preferred, non-limiting, embodiment of a ventilation system, as illustrated in the accompanying drawing in which the ventilation system according to the invention is represented in a diagram, partly in blocks.

### DETAILED DESCRIPTION OF THE PREFERRED EMBODIMENTS OF THE INVENTION

The numeral 1 in the accompanying drawing denotes a ventilation system for a generic vehicle, not illustrated, according to the invention.

The system 1 comprises an electric ventilator 2 which, as explained below, is referred to as “master”, in turn comprising an electric motor 3 and a fan 4 driven by the motor 3.

The electric ventilator 2, preferably of the axial type, comprises means 5, associated with the motor 3, for controlling the rotation speed of the motor 3 itself and hence of the fan 4.

The control means 5 preferably comprise a computerized control unit 6, generally represented as a microcontroller 6, installed on board the motor 3 and designed to control the speed of the motor 3.

In the system 1 according to the invention, the microcontroller 6 is structured or programmed not only to control the rotation speed, but also to acquire and process one or more of the vehicle's functional parameters, that is, parameters relating to vehicle operation, on the basis of which a control signal is generated and translated into the speed of the motor 3.

In other words, the microcontroller 6 constitutes processing means 7 that can be associated with the vehicle to process the latter's functional parameters used to define the rotation speed of the motor 3.

In alternative embodiments not illustrated the control means 5 comprise a first microcontroller designed to control the rotation speed and a second microcontroller constituting the above mentioned processing means 7 for processing the functional parameters acquired from the vehicle and generating a control signal for the first microcontroller.

The control means 5 are therefore designed to control the motor 3 but also to implement logics which, in practice, can determine the optimum rotation speed of the motor 3 according to the needs to remove air from the vehicle or from the radiating bodies mounted in the vehicle.

Advantageously, the control means 5 have a plurality of inputs 9, 10, 11 through which the processing means 7 acquire the functional parameters of the vehicle.

Through the inputs 9, 10, 11 the signals indicative of the quantities of interest reach the processing means 7 which process them as described above.

In the preferred embodiment illustrated by way of an example, the system 1 comprises a temperature sensor 12 that can be associated with a cooling circuit having a radiating body 13, schematically represented, for the vehicle's propellant to monitor the temperature of the cooling liquid.

The information thus obtained is sent through the input 9 to the microcontroller 6.

The system comprises a pressure sensor 14 that can be associated with a cabin air conditioning system, schematically represented by a condenser 15, for detecting the pressure of the coolant in the system 15.

The information thus obtained is sent through the input 10 to the microcontroller 6 which uses it to process the optimum rotation speed of the fan 4.

The control means 5, suitably equipped with the processing means 6, constituting the part of the electric ventilator 2 known in its entirety as the “electronics”, are thus able to acquire the temperature of the coolant and the pressure of the air conditioning system and to translate this information into the optimum rotation speed of the fan 4.

Obviously, in alternative embodiments not illustrated, the control means 5 are provided with a plurality of inputs, only one of which, labelled 11, is shown in the drawing, depending on the type and number of parameters to be used to control the speed of the fan 4.

It should be noted that in alternative embodiments, the sensors 12, 14 forming part of the system 1 are ready fitted in the vehicle and the information provided by them is sent to the inputs 9, 10 of the control means 5.

As illustrated in the drawing, the ventilation system 1 comprises a second electric ventilator 16, referred to, for clarity of description, as “slave”.

The second electric ventilator 16 is also of the axial type and has performance data and technical specifications analogous to those of the “master” electric ventilator.

In the case of large radiating bodies, two or more electric ventilators may be used to extract the heat.

In the embodiment illustrated, the “master” electric ventilator is combined with the “slave” electric ventilator 16.

The electric ventilator 16 comprises respective control means 17 designed to translate the control signal generated by the processing means 7 of the electric ventilator 2 into the rotation speed of the corresponding fan 18 driven by a motor 19.

The control means 5 of the electric ventilator 2 comprise an output 20 for driving the “slave” electric ventilator 16.

The electric ventilator 16 has an input 21 placed in communication with the output 20 of the electric ventilator 2 from which it receives the same control signal generated by the processing means 7 for the control means 5 of the electric ventilator 2.

In practice, therefore, in the system 1 as described a main electric ventilator, labelled 2 in the example, is equipped with the microcontroller 6 which is able to process the signals from suitable sensors 12, 14 and to generate a control signal that must be translated into an optimum rotation speed for the fans 4, 18.

The microcontroller 6 itself translates the control signal into the rotation speed for the fan 4; the same control signal is sent to the electric ventilator 16 where the control means 17 translate it into the optimum rotation speed for the fan 18.

Advantageously, the rotation speeds of the fans 4 and 18 are substantially the same so as to also reduce noise more effectively.

In alternative embodiments, the system 1 comprises a plurality of “slave” electric ventilators, illustrated schematically with dashed lines and labelled 22, each having a respective input 24 for the respective electronics 25, all driven by the control means 5 of the “master” electric ventilator.

For this purpose, the electric ventilator 2 has one or more outputs 26 for driving the further electric ventilators 16.

In alternative embodiments not illustrated, the electric ventilator 2 comprises a plurality of outputs 20 through which a control signal suitably processed by the microcontroller 6 is sent to the devices in the vehicle which, therefore, are in practice driven by the electric ventilator 2.

Preferably, for example, one control signal is sent to the water pump of the cooling circuit or to a solenoid valve along the cooling circuit to regulate the flow rate of the coolant according to the temperatures measured.

It is important to note that the application of a system 1 as described in the foregoing is also particularly advantageous in the cabin of the vehicle.

In this case, the electric ventilator 2 is a centrifugal ventilator and the sensor associated with its control means 5 is a temperature sensor for monitoring the temperature of the air in the cabin. The rotation speed of the fan is determined by the microcontroller 6 according to the cabin temperature.

The invention has important advantages.

The fact that the electric ventilator is itself provided with sophisticated processing means allows the system 1 to be mounted also on vehicles without particularly advanced control units, enabling the thermal and cooling flows to be optimized.

If the vehicle is, or can be expected to be, equipped with temperature sensors, generically illustrated by the dashed line and schematically represented as a block 23, for example to monitor the oil temperatures of gearbox, cylinder head and engine, or to measure engine rpm, the respective quantities can be used as input for the microcontroller; in this way, even in the presence of two or more radiating bodies, each used for a specific purpose, the rotation speed of the cooling fans is optimally calibrated.

Thus, the electric ventilator equipped with the control means 5 can itself directly process the information from the sensors which, in practice, determine the speed of the fan.

The use of a “master” electric ventilator and one or more “slave” electric ventilators enables the efficiency of the former to be applied effectively to the latter to create a ventilation system that is at once inexpensive, versatile and efficient.

The invention described above may be modified and adapted in several ways without thereby departing from the scope of the inventive concept, as defined in the claims herein.

Moreover, all the details of the invention may be substituted by technically equivalent elements.

1. A ventilation system for vehicles comprising:
at least one electric ventilator comprising a fan, an electric motor for driving the fan and control means installed at the motor for controlling the rotation speed of the fan, wherein the control means comprise processing means for processing at least one vehicle functional parameter used to generate a signal for controlling at least the electric ventilator.

2. The system according to claim 1, wherein the processing means can be associated with the vehicle to process the functional parameter used to define at least the speed of rotation.

3. The system according to claim 1, wherein the control means have at least one input for the functional parameter.

4. The system according to claim 1, wherein the control means have at least one output for the functional parameter.

5. The system according to claim 1, wherein the processing means comprise at least one temperature sensor for detecting the functional parameter.

6. The system according to claim 1, wherein the processing means comprise at least one pressure sensor for detecting the functional parameter.

7. The system according to claim 1, wherein the control means comprise a computerized control unit for controlling the rotation speed of the fan and processing the functional parameter.

8. The system according to claim 1, wherein it comprises at least one second electric ventilator comprising a second respective fan and controlled by the processing means of the first electric ventilator for controlling the rotation speed of the second fan.

9. The system according to claims 8, wherein the control means have at least one input for the functional parameter and the second electric ventilator receives the control signal from the output, the second electric ventilator having a respective input for the control signal.
